(19) United States
(12) Patent Application Publication
(10) Pub. No.: US 2024/0248713 A1
(43) Pub. Date: Jul. 25, 2024

(54) VECTOR PROCESSOR PERFORMING VECTOR AND ELEMENT REDUCTION METHOD WITH SAME CIRCUIT STRUCTURE

(71) Applicant: ANDES TECHNOLOGY CORPORATION, Hsinchu City (TW)

(72) Inventor: Chia-Wei Hsu, Tainan City (TW)

(73) Assignee: ANDES TECHNOLOGY CORPORATION, Hsinchu City (TW)

(21) Appl. No.: 18/582,614

(22) Filed: Feb. 20, 2024

Related U.S. Application Data
(62) Division of application No. 17/855,816, filed on Jul. 1, 2022.

(51) Int. Cl. G06F 9/30; G06F 9/345; G06F 9/38; G06F 15/80

(52) U.S. Cl. CPC G06F 9/30036; G06F 9/3001; G06F 9/30029; G06F 9/30038; G06F 9/345; G06F 9/3887; G06F 15/8053

(57) ABSTRACT

A vector processor performing a vector reduction method and an element reduction method with the same circuit structure is provided. The vector processor includes a vector register file and a first lane. The first lane loads a first operand and a second operand based on a first state parameter and performs a first reduction operation on the first operand and the second operand to generate a first reduction result. The first lane performs a second reduction operation on the first and second parts of the first reduction result based on a second state parameter to generate a second reduction result.

### CROSS-REFERENCE TO RELATED APPLICATION

This application is a divisional application of and claims the priority benefit of a prior application Ser. No. 17/855,816, filed on Jul. 1, 2022. The entirety of the above-mentioned patent application is hereby incorporated by reference herein and made a part of this specification.

### BACKGROUND OF THE INVENTION

### Field of the Invention

The invention relates to a vector processor, and more particularly, to a vector processor configured to perform vector reduction and element reduction.

### Description of Related Art

Single instruction multiple data (SIMD) is widely used for parallel data processing of vector processors. In general, vector processors may use vector reduction and element reduction to reduce vector data to scalar values. However, when vector reduction and element reduction are implemented in a fully pipelined manner in the prior art, due to the doubling of computational logic and the huge wire connection for element data shuffling, circuit area bloating could increase power dissipation, and also creates congestion problems and timing problems. Moreover, when the vector processor is configured for floating point reduction, dot product, larger vector register length (VLEN), or data path length (DLEN) such as 512, 1024, or 2048 bits, the above problems are exacerbated.

### SUMMARY OF THE INVENTION

The invention provides a vector processor performing a vector and element reduction methods with the same circuit structure, which can flexibly adjust the number of iterations to optimized hardware performance indicators or software performance indicators.

An embodiment of the invention provides a vector processor. The vector processor includes a vector register file and a first lane. The first lane is coupled to the vector register file to load a first operand and a second operand based on a first state parameter and performs a first reduction operation on the first operand and the second operand to generate a first reduction result, and performs a second reduction operation on a first part and a second part of the first reduction result based on a second state parameter to generate a second reduction result.

An embodiment of the invention provides an element reduction method. The element reduction method includes: loading a first operand and a second operand based on a first state parameter and performing a first reduction operation on the first operand and the second operand to generate a first reduction result, and performing a second reduction operation on a first part and a second part of the first reduction result based on a second state parameter to generate a second reduction result.

Based on the above, in some embodiments of the invention, the vector processor may execute different steps in the reduction operation with the same circuit based on the state parameters, thereby saving circuit area and improving reduction operation performance. Moreover, the vector processor may perform the vector reduction operation and the element reduction operation with the same circuit structure, so as to further save circuit area.

In order to make the aforementioned features and advantages of the disclosure more comprehensible, embodiments accompanied with figures are described in detail below.

### BRIEF DESCRIPTION OF THE DRAWINGS

FIG. 1 is a block diagram of a vector processor according to an embodiment of the invention.

FIG. 2 is a schematic diagram of a finite state machine for vector reduction operations according to an embodiment of the invention.

FIG. 3 is a schematic diagram of an arithmetic logic operation unit according to an embodiment of the invention.

FIG. 4 is a schematic diagram of step S210 of a vector reduction method according to an embodiment of the invention.

FIG. 5A is a schematic diagram of step S220 of a vector reduction method according to an embodiment of the invention.

FIG. 5B is a schematic diagram of step S220 of a vector reduction method according to an embodiment of the invention.

FIG. 6 is a schematic diagram of normal reduction in step S230 of a vector reduction method according to an embodiment of the invention.

FIG. 7 is a schematic diagram of fast reduction in step S230 of a vector reduction method according to an embodiment of the invention.

FIG. 8 is a schematic diagram of a finite state machine for element reduction operations according to an embodiment of the invention.

FIG. 9 is a schematic diagram of an arithmetic logic operation unit according to an embodiment of the invention.

FIG. 10A is a schematic diagram of step S810 of an element reduction method according to an embodiment of the invention.

FIG. 10B is a schematic diagram of step S810 of an element reduction method according to another embodiment of the invention.

FIG. 11 is a schematic diagram of normal reduction in step S820 of an element reduction method according to an embodiment of the invention.

FIG. 12 is a schematic diagram of fast reduction in step S820 of an element reduction method according to an embodiment of the invention.

FIG. 13 is a schematic diagram of the fast reduction in steps S230 and S820 of an integer sum vector reduction and an integer sum element reduction method according to an embodiment of the invention.

FIG. 14 is a flowchart of a vector reduction operation according to an embodiment of the invention.

FIG. 15 is a flowchart of an element reduction operation according to an embodiment of the invention.

### DESCRIPTION OF THE EMBODIMENTS

The term “coupled to (or connected to)” used in the entire text of the specification of the present application (including claims) may refer to any direct or indirect connecting means. For example, if the text describes a first device is coupled to (or connected to) a second device, then it should be understood that the first device may be directly connected to the second device, or the first device may be indirectly connected to the second device via other devices or certain connecting means. Moreover, when applicable, devices/components/steps having the same reference numerals in figures and embodiments represent the same or similar parts.

Elements/components/steps having the same reference numerals or having the same terminology in different embodiments may be cross-referenced.

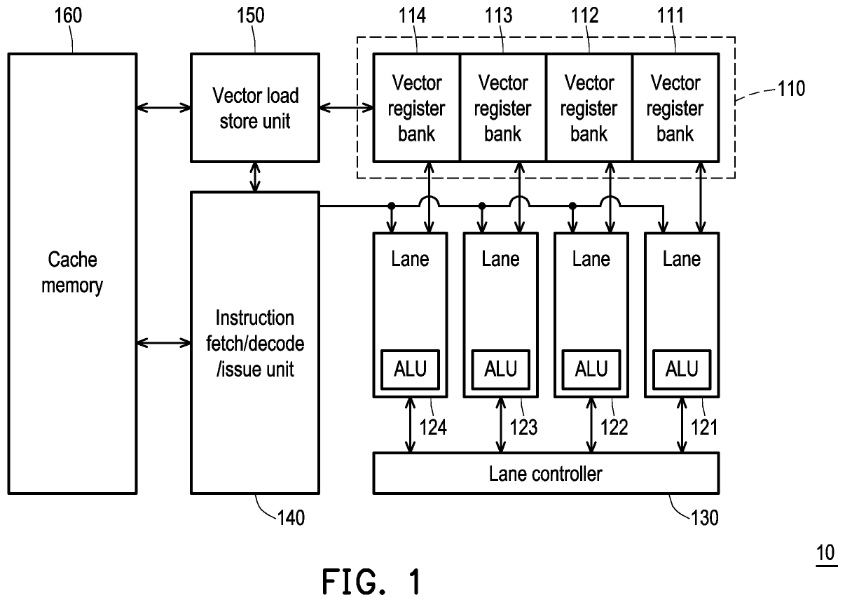

FIG. 1 is a block diagram of a vector processor according to an embodiment of the invention. Referring to FIG. 1, the vector processor 10 may include a vector register file 110, a lane 121 to a lane 124, a lane controller 130, an instruction fetch/decode/issue unit 140, a vector load store unit 150, and a cache memory 160. The vector register file 110 may include a vector register bank 111, a vector register bank 112, a vector register bank 113, and a vector register bank 114 configured to temporarily store input vector data, intermediate results of vector operations, or output vector data, in order to avoid accessing to the cache memory 160 or a memory (not shown) located outside the vector processor 10 frequently. The vector register bank width of each vector register bank is, for example, 64 bits. Each vector register bank may include a plurality of vector registers, e.g., 32 vector registers. The lanes 121 to 124 are coupled to the vector register file 110, and each of the lanes 121 to 124 includes one arithmetic logic unit ALU. Each vector register bank is coupled to the corresponding lane, for example, the vector register bank 111 provides data to the lane 121. In the present embodiment, the arithmetic logic unit ALU in the lane 121 to the lane 124 may be a single instruction multiple data ALU (SIMD_ALU). The number of operations per lane is the same as the vector register bank width, e.g., 64 bits. In SIMD_ALU, the number of elements in each lane depends on the register bank width and an element length ELEN. For example, if the element length ELEN is 8 bits, each lane has 64/8=8 elements. If the element length ELEN is 16 bits, each lane has 64/16=4 elements. Moreover, in SIMD_ALU, the operation result of each element does not affect (carry) to other elements. The lane controller 130 is coupled to the lane 121 to the lane 124, and the lane controller 130 may control the data transmission of the lane 121 to the lane 124. It should be noted that the number of vector register banks, lanes, and vector registers in FIG. 1 is only an example, and is not limited thereto. The instruction fetch/decode/issue unit 140 is capable of fetching instructions from the cache memory 160. The instruction fetch/decode/issue unit 140 decodes the fetched instructions and issues commands to the lanes 121 to 124, and the vector load store unit 150. Based on the decoded result, the lanes 121 to 124, and the vector load store unit 150 may perform relevant functional operations in association with the fetched instruction. In the present embodiment, the commands include at least one micro-operation, and the arithmetic logic unit ALU in the lane 121 to the lane 124 may perform vector reduction operations and element reduction operations based on the micro-operation. The vector load store unit 150 is configured to read vectors from the cache memory 160, and load the vectors into the vector register file 110 based on the commands. The cache memory 160 is configured to store program codes of instructions and data that are needed for the execution of the instructions.

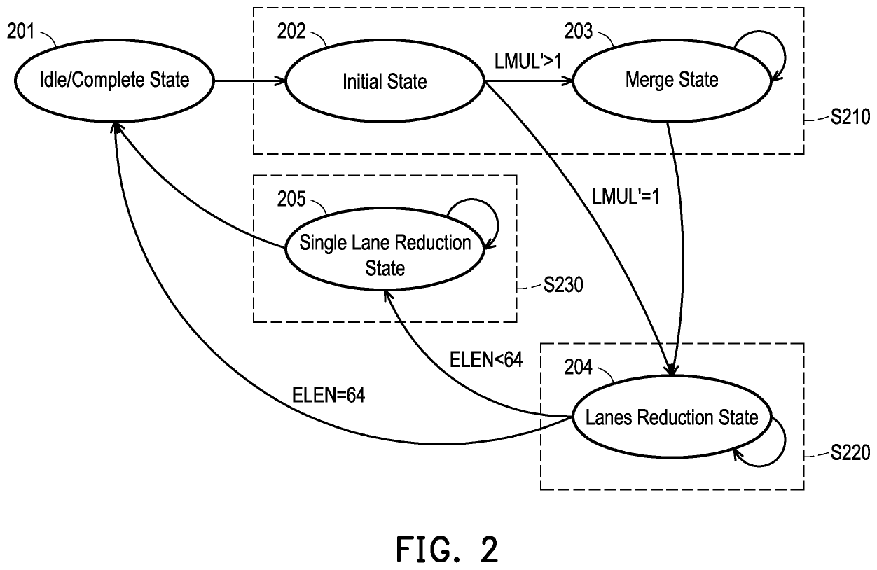

FIG. 2 is a schematic diagram of a finite state machine (FSM) for vector reduction operations according to an embodiment of the invention. Referring to FIG. 2, the FSM of the vector reduction operation may include an Idle/Complete State 201, an Initial State 202, a Merge State 203, a Lanes Reduction State 204, and a Single Lane Reduction State 205, and each state corresponds to a different parameter STATE. In particular, the vector reduction operation includes at least steps S210 and S220. Step S210 includes at least the Initial State 202, and step S220 includes the Lanes Reduction State 204. Step S210 may also include the Merge State 203 based on the value of a unit vector length multiplier LMUL′, and the vector reduction operation based on the element length ELEN may further include step S230, and step 230 includes the Single Lane Reduction State 205. The arithmetic logic unit ALU and the lane controller 130 of FIG. 1 may perform various actions in different states based on the various parameter STATE in the vector reduction operation. The implementation details of the above states will be described in detail later.

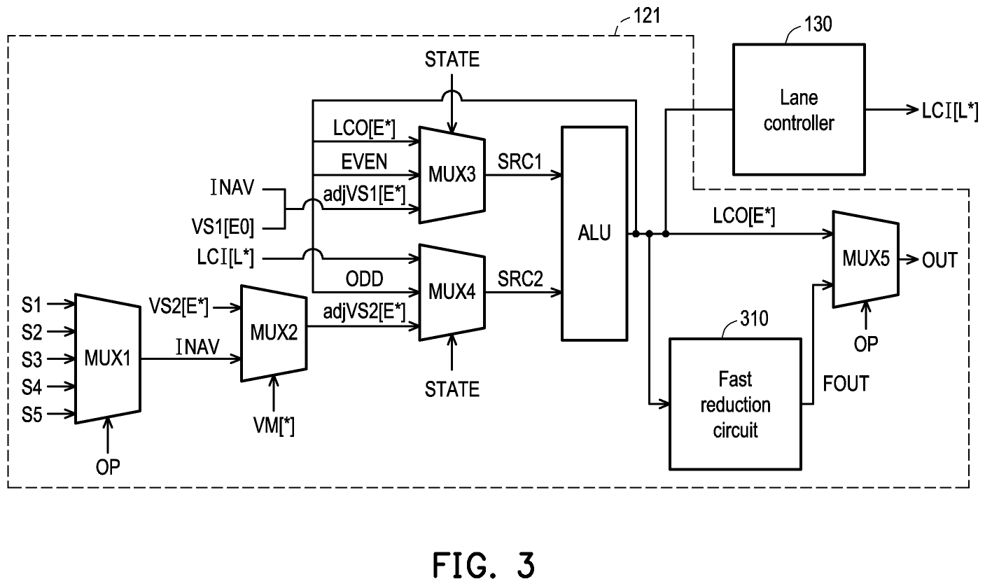

FIG. 3 is a schematic diagram of an arithmetic logic operation unit according to an embodiment of the invention. Please refer to FIG. 1 and FIG. 3, each of the lane 121 to the lane 124 configured for vector reduction operations may include at least a multiplexer MUX1 (first multiplexer), a multiplexer MUX2 (second multiplexer), a multiplexer MUX3 (third multiplexer), a multiplexer MUX4 (fourth multiplexer), the arithmetic logic unit ALU, a fast reduction circuit 310, and a multiplexer MUX5 (fifth multiplexer).

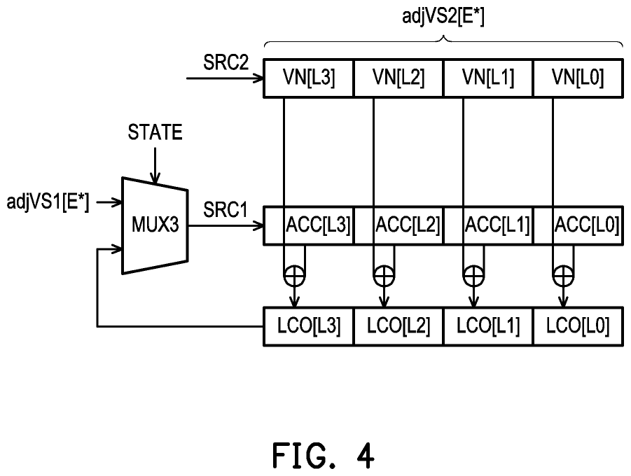

FIG. 4 is a schematic diagram of step S210 of a vector reduction method according to an embodiment of the invention. Please refer to FIG. 2, FIG. 3, and FIG. 4. In the Idle/Complete State 201, after the instruction fetch/decode/issue unit 140 issues the first micro-operation, the vector processor 10 proceeds to step S210 to perform a vector reduction operation (first reduction operation). Step S210 includes at least the Initial State 202. In the Initial State 202, the lane 121 may select an inactive value INAV from one of the inactive value signal S1 to inactive value signal S5 based on an operator OP, and output the inactive value INAV to the multiplexer MUX2. For the selection of the inactive value INAV depended on OP, please refer to Table 1. For example in FIG. 3, when the arithmetic logic operation of an input source SRC1 (first input source) and an input source SRC2 (second input source) is SUM, the multiplexer MUX1 selects the signal S5 and the inactive value INAV is 0 (i.e. value of S5). It should be noted that FIG. 3 is only an example, and the invention may also be other arithmetic operations and logic operations, which are not limited thereto.

TABLE 1

| OP (operator) | INAV (inactive value) |
|---|---|
| AND | S1 = All 1 s |
| OR/XOR | S2 = All 0 s |
| MIN | S3 = MAX |
| MAX | S4 = MIN |
| SUM | S5 = 0 |

In the present embodiment, the operand VS1[E0] (Element 0) in the operand VS1[E*] read from the vector register file 110 needs to be reduced, and the part of the operand VS1I[E*] except the operand VS1[E0] is masked (no reduction operation is needed, that is, inactive elements) and filled with the inactive value INAV, thus an operand adjVS1I[E*] (adjusted first operand) is generated. In particular, VS1[E*] represents all elements in the operand VS1, and the operand VS1[E0] represents the 0th element of VS1. It should be noted that the operation of the elements filled with the inactive value INAV is an invalid operation, so in fact, although the reduction operation is still performed, the result is equivalent to no reduction operation.

A plurality of multiplexers MUX2 may select the elements that do not need to be masked (a reduction operation is needed) in an operand VS2[E*] read from the vector register file 110 based on a mask-bit VM[*], and replace the elements in the operand VS2[E*] that need to be masked (a reduction operation is not needed, that is, inactive elements) with the inactive value INAV, thus an operand adjVS2[E*] (adjusted second operand) is generated. In particular, the mask-bit VM[*] represents all mask bits.

Then, the multiplexer MUX3 may select the operand adjVS1[E*] based on the state parameter STATE corresponding to the Initial State 202 as the input source SRC1, and the multiplexer MUX4 may select the operand adjVS2[E*] based on the state parameter STATE corresponding to the Initial State 202 as the input source SRC2. The arithmetic logic unit ALU is coupled to the output of the multiplexer MUX3 and the output of the multiplexer MUX4. The arithmetic logic unit ALU performs arithmetic logic operations on the input source SRC1 and the input source SRC2 to generate a lane output LCO[E*].

Regarding the arithmetic logic operations performed by the arithmetic logic unit ALU on the input source SRC1 and the input source SRC2 in the Initial State 202, please refer to FIG. 4. The arithmetic logic unit ALU in the lane 121 to the lane 124 may respectively load the SRC1 to the registers ACC[L0] to ACC[L3], and load the SRC2 to the registers VN[L0] to VN[L3]. The register ACC[L0] represents the register in the 0th lane, and so on. The registers ACC[L0] to ACC[L3] and the registers VN[L0] to VN[L3] are respectively disposed in the lanes 121 to 124. In particular, the register VN[L0] represents the register in the 0th lane, and so on. In particular, an operand adjVS1[L0] (not shown) in the operand adjVS1[E*] in FIG. 4 is loaded into the register ACC[L0], and the other parts of the operand adjVS1I[E*] are loaded into the registers ACC[L1] to ACC[L3] respectively. In particular, the operand adjVS1[L0] represents the part of the operand adjVS1 in the 0th lane. Next, the arithmetic logic unit ALU of the lane 121 accumulates the data in the register ACC[L0] and the register VN[L0] to generate a lane output LCO[L0] of the lane 121. The arithmetic logic unit ALU of the lane 122 accumulates the data in the register ACC[L1]and the register VN[L1] to generate a lane output LCO[L1] of the lane 122. The arithmetic logic unit ALU of the lane 123 accumulates the data in the register ACC[L2] and the register VN[L2] to generate a lane output LCO[L2] of the lane 123. The arithmetic logic unit ALU of the lane 124 accumulates the data in the register ACC[L3] and the register VN[L3] to generate a lane output LCO[L3] of the lane 124. In particular, the lane output LCO[L0] represents the lane output of the 0th lane, and so on.

For example, in the Initial State 202, the vector processor 10 may load the operand adjVS1[L0] to the register ACC[L0] and load the operand adjVS2[L0] (not shown) to VN[L0], and use the accumulation result of the operand adjVS1I[L0] and the operand adjVS2[L0] as the lane output LCO[L0]. The vector processor 10 loads the inactive value INAV to the register ACC[L1] via the operand adjVS1[L1] and loads the operand adjVS2[L1] to the register VN[L1], and uses the accumulation result (that is, the operand adjVS2[L1]) of the inactive value INAV and the operand adjVS2[L1] as the lane output LCO[L1]. The vector processor 10 loads the inactive value INAV to the register ACC[L2] via the operand adjVS1[L2] and loads the operand adjVS2[L2] to the register VN[L2], and uses the accumulation result of the inactive value INAV and the operand adjVS2[L2] as the lane output LCO[L2]. The vector processor 10 loads the inactive value INAV to the register ACC[L3] via the operand adjVS1[L3] and loads the operand adjVS2[L3] to the register VN[L3], and uses the accumulation result of the inactive value INAV and the operand adjVS2[L3] as the lane output LCO[L3]. In an embodiment, the lane output LCO[L0] to the lane output LCO[L3] are, for example, 64 bits respectively, for a total of 256 bits.

Returning to FIG. 2, following the Initial State 202, the vector processor 10 determines whether to perform iteration operations based on the unit vector length multiplier LMUL′. When the unit vector length multiplier LMUL′ is greater than 1, the state parameter STATE is changed to the Merge State 203 and the lane 121 to the lane 124 perform the iteration operations. When the unit vector length multiplier LMUL′ is equal to 1, the state parameter STATE is changed to the Lanes Reduction State 204 and the lane 121 to the lane 124 do not perform the iteration operations. The unit vector length multiplier LMUL′ is the number of the micro-operations issued in each command by the instruction fetch/decode/issue unit 140, and the unit vector length multiplier LMUL′ is shown in formula (1).

$${LMUL}^{′} = LMUL * \frac{VLEN}{DLEN} \qquad ( 1 )$$

In particular, LMUL is the vector length multiplier. When the vector length multiplier LMUL is 1, one command may operate one vector register, and when the vector length multiplier LMUL is greater than 1, one command may operate LMUL vector registers. The vector length multiplier LMUL combines a plurality of vector registers into one vector register group. For example, if the vector length multiplier LMUL is 4 in the vector reduction operation, the operand adjVS2[E*], i.e. one vector register group, consists of 4 vector registers. VLEN is the vector register length, that is the width of each vector register in the vector register file 110, for example, 256 bits. The vector register length VLEN is equal to the sum of the widths of the vector register bank 111, the vector register bank 112, the vector register bank 113, and the vector register bank 114. DLEN is the data path length, that is the data width of one operation, for example, 256 bits. In an example of the invention, the vector register length VLEN is equal to the data path length DLEN, but the vector register length VLEN may also not be equal to the data path length DLEN, which is not limited thereto.

Specifically, referring to FIG. 3 and FIG. 4, the multiplexer MUX3 may select the operand adjVS1[E*] as the input source SRC1 based on the state parameter STATE corresponding to the Initial State 202. When the unit vector length multiplier LMUL′ is greater than 1, the multiplexer MUX3 may select the lane output LCO[E*] as the input source SRC1 based on the state parameter STATE corresponding to the Merge State 203.

Please refer to FIG. 2, FIG. 3, and FIG. 4, in the Merge State 203, the lane 121 performs iteration operations on the lane output LCO[L0] (the result of the first reduction operation) based on the state parameter STATE corresponding to the Merge State 203. For example, in the Initial State 202, the operand adjVS1I[L0] may be loaded to the register ACC[L0] and the operand adjVS2[L0] may be loaded to the register VN[L0], and the accumulation result of the operand adjVS1I[L0] and the operand adjVS2[L0] may be used as the lane output LCO[L0]. Next, in the Merge State 203, the lane 121 loads an operand adj(VS2+1)[L0] (not shown) to the register VN[L0], and via the multiplexer MUX3, loads the lane output LCO[L0] to the register ACC[L0] through the input source SRC1, and uses the accumulation result of “adjVS1[L0]+adjVS2[L0]” and the operand adj(VS2+1)[L0] as the new lane output LCO[L0]. In particular, the operand adj(VS2+1)[L0] represents the 0th lane part of the operand (VS2+1) which is the second vector register of the vector register group of operand VS2. In the present embodiment, the lanes 121 to 124 may perform a plurality of iteration operations respectively based on the unit vector length multiplier LMUL′. For example, the lane 121 uses the accumulation result of the operands adjVS1[L0], adjVS2[L0] to adj(VS2+7)[L0] as the lane output LCO[L0] of a plurality of iteration operations, the lane 122 uses the accumulation result of the inactive value INAV and adjVS2[L1] to adj(VS2+7)[L1] as the lane output LCO[L1] of a plurality of iteration operations, the lane 123 uses the accumulation result of the inactive value INAV and adjVS2[L2] to adj(VS2+7)[L2] as the lane output LCO[L2] of a plurality of iteration operations, and the lane 124 uses the accumulation result of the inactive value INAV and adjVS2[L3] to adj(VS2+7)[L3] as the lane output LCO[L3] of a plurality of iteration operations. In particular, the operand adj(VS2+7)[L0] represents the 0th lane part of the operand (VS2+7) which is the 8th vector register of the vector register group of operand VS2. In an embodiment, the lane output LCO[L0] to the lane output LCO[L3] are, for example, 64 bits respectively, for a total of 256 bits.

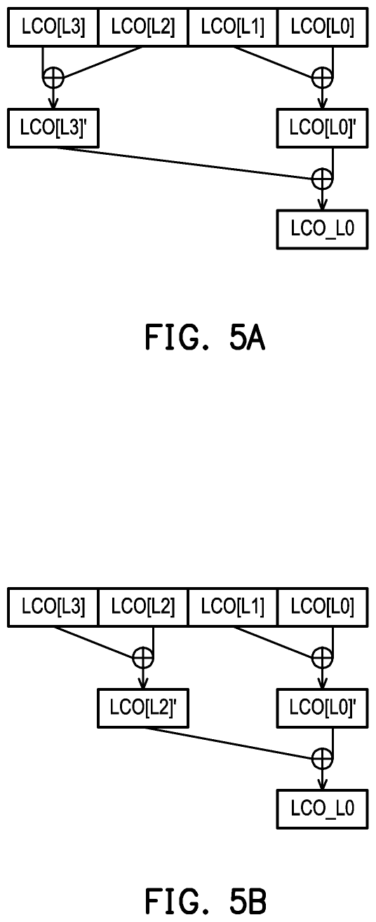

FIG. 5A is a schematic diagram of step S220 of a vector reduction method according to an embodiment of the invention. FIG. 5B is a schematic diagram of step S220 of a vector reduction method according to an embodiment of the invention. Please refer to FIG. 2, FIG. 3, FIG. 5A, and FIG. 5B, in the Lanes Reduction State 204 in step S220, the lane 121 to the lane 124 may perform a reduction operation (second reduction operation) on the lane output LCO[L0] to the lane output LCO[L3] based on the state parameter STATE corresponding to the Lanes Reduction State 204 to generate a reduced lane output LCO_L0 (second reduction result). Referring to FIG. 3 and FIG. 5A, the lane controller 130 may receive the lane output LCO[L*] of a plurality of lanes, and provide the lane output LCO[L*] to other lanes as a lane input LCI[L*]. Specifically, the multiplexer MUX3 may select the lane output LCO[L*] as the input source SRC1 based on the state parameter STATE corresponding to the Lanes Reduction State 204. The multiplexer MUX4 may select the lane input LCI[L*] as the input source SRC2 based on the state parameter STATE corresponding to the Lanes Reduction State 204. The arithmetic logic unit ALU may accumulate the lane output LCO[L*] and the lane input LCI[L*] respectively belonging to two different lanes to reduce to single lane output LCO[L*]′. The reduction operation may be iterated to reduce a plurality of lane outputs LCO[L*] to a single reduced lane output LCO[L*], for example, four lane outputs LCO[L*] are reduced to a reduced single lane output LCO_L0.

For example, in FIG. 5A, the vector processor 10 accumulates the lane output LCO[L3] and the lane output LCO[L2] into a reduced lane output LCO[L3]′, accumulates the lane output LCO[L1] and the lane output LCO[L0] into a reduced lane output LCO[L0]′, and accumulates the reduced lane output LCO[L3]′ and the reduced lane output LCO[L0]′ again as the reduced single lane output LCO_L0. In FIG. 5B, the vector processor 10 accumulates the lane output LCO[L3] and the lane output LCO[L2] into a reduced lane output LCO[L2]′, accumulates the lane output LCO[L1] and the lane output LCO[L0] into a reduced lane output LCO[L0]′, and accumulates the reduced lane output LCO[L2]′ and the reduced lane output LCO[L0]′ again as the reduced single lane output LCO_L0. It should be mentioned that, the reduction combination of FIG. 5A and FIG. 5B is only an example, and in other embodiments, it may also be other reduction combinations. For example, the lane output LCO[L3] and the lane output LCO[L1] are accumulated first, and also the lane output LCO[L2] and the lane output LCO[L0] are accumulated, and then the two accumulation results are accumulated, or other number of lane reductions, but the invention is not limited thereto. In an embodiment, the width of the reduced single lane output LCO_L0 (second reduction result) (for example, 64 bits) is equal to the width of each of the lane output LCO[L0], the lane output LCO[L1], the lane output LCO[L2], and the lane output LCO[L3] (first reduction result).

After the Lanes Reduction State 204 in step S220 is completed, the vector processor 10 may determine whether the element length ELEN is smaller than the length of a single lane, and based on the determination result, decide whether to perform one of a normal reduction operation or a fast reduction operation on the reduced single lane output LCO_L0. When the element length ELEN is less than the length of a single lane, the state parameter STATE is changed to the Single Lane Reduction State 205 in step S230 to perform one of a normal reduction operation or a fast reduction operation on the reduced single lane output LCO_L0. When the element length ELEN is equal to the length of a single lane, the state parameter STATE is changed to the Idle/Complete State 201 without performing any reduction operation on the reduced single lane output LCO_L0, and the value of the reduced single lane output LCO_L0 is used as the result of the vector reduction operation.

In an embodiment, the length of a single lane is, for example, 64 bits. When the element length ELEN is less than 64 bits, the vector processor 10 enters the Single Lane Reduction State 205 in step S230 to perform one of a normal reduction operation or a fast reduction operation, and when the element length ELEN is equal to 64 bits, the vector processor 10 enters the Idle/Complete State 201 without performing any of a normal reduction operation or a fast reduction operation. It should be mentioned that, in the Single Lane Reduction State 205 in step S230, based on design requirements, the vector processor 10 may perform the normal reduction operation via the multiplexer MUX3, the multiplexer MUX4, the multiplexer MUX5, and the arithmetic logic unit ALU in the lane 121, or may perform the fast reduction operation via the multiplexer MUX3, the multiplexer MUX4, the multiplexer MUX5, the arithmetic logic unit ALU, and the fast reduction circuit 310 in the lane 121. The selection of the normal reduction operation and the fast reduction operation may be realized by the operator OP for the multiplexer MUX5. For example, when the operator OP is arithmetic logic reduction such as SUM reduction, the normal reduction operation is selected, and when the operator OP is bitwise logic reduction, such as OR reduction, a fast reduction operation is selected, but the invention is not limited thereto.

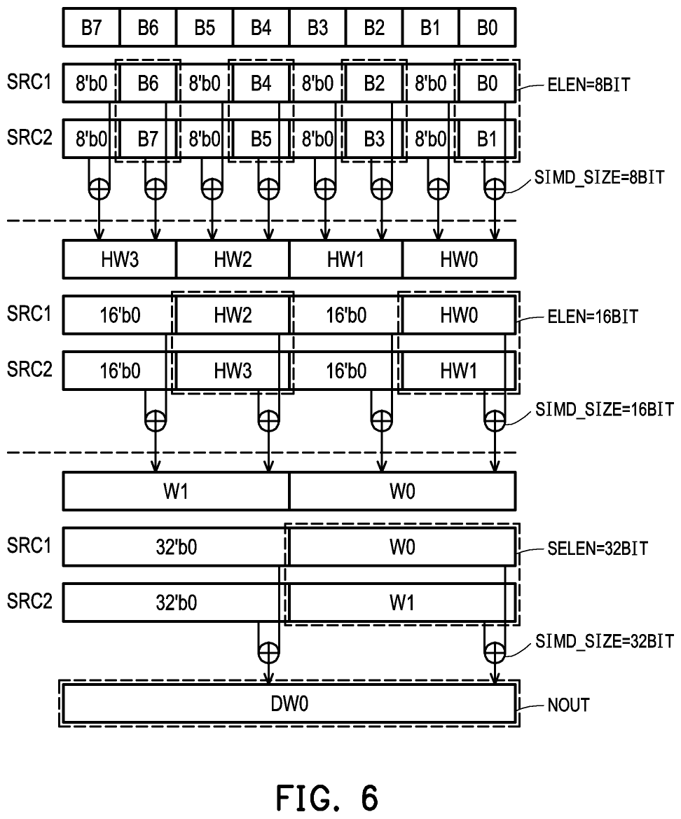

FIG. 6 is a schematic diagram of normal reduction in step S230 of a vector reduction method according to an embodiment of the invention. Referring to FIG. 2, FIG. 3, and FIG. 6, in the Single Lane Reduction State 205 in step S230, the vector processor 10 may perform one of a normal reduction operation or a fast reduction operation. In the normal reduction operation, the vector processor 10 determines the number of iterations based on the element length ELEN for performing arithmetic logic operations on a plurality of even-numbered parts and a plurality of odd-numbered parts in the reduced single lane output LCO_L0 (second reduction result) to generate a normal reduction output NOUT (normal reduction result). In an embodiment, when the element length ELEN is 8 bits, the lane output LCO_L0 (second reduction result) may be divided into 8 bytes such as bytes B7 to B0 (that is, byte7 to byte0), and each of the bytes B7 to B0 consists of 8 bits, wherein the bytes B7, B5, B3, and B1 belong to an odd-numbered part ODD, and the bytes B6, B4, B2, and B0 belong to an even-numbered part EVEN. When the element length ELEN is 16 bits, the lane output LCO_L0 may be divided into 4 bytes such as bytes HW3 to HW0 (that is, Half-word3 to Half-word0), and each of the bytes HW3 to HW0 consists of 16 bits, wherein the bytes HW3 and HW1 belong to an odd-numbered part ODD and the bytes HW2 and HW0 belong to an even-numbered part EVEN. When the element length ELEN is 32 bits, the lane output LCO_L0 may be divided into 2 bytes such as bytes W1 and W0 (that is, Word1 and Word0), and each of the bytes W1 and W0 consists of 32 bits, wherein the byte W1 belongs to an odd-numbered part ODD and the byte W0 belongs to an even-numbered part EVEN.

When the element length ELEN is 8 bits, the vector processor 10 uses the bytes B6, B4, B2, and B0 in the lane output LCO_L0 (second reduction result) as the input source SRC1, and uses the bytes B7, B5, B3, and B1 in the lane output LCO_L0 as the input source SRC2. Specifically, the multiplexer MUX3 may select the even-numbered part EVEN of the lane output LCO_L0 as the input source SRC1 based on the state parameter STATE corresponding to the normal reduction operation, and the multiplexer MUX4 may select the odd-numbered part ODD of the lane output LCO_L0 as the input source SRC2 based on the state parameter STATE corresponding to the normal reduction operation. In an embodiment, the arithmetic logic unit ALU may add 4 groups of 8′b0 to the input source SRC1 and the input source SRC2 respectively, and performs 8 sets of accumulation operations with an operation width SIMD_SIZE of 8 bits on the input source SRC1 and the input source SRC2, thereby generating the bytes HW3, HW2, HW1, and HW0, wherein the bytes HW3, HW2, HW1, and HW0 are all 16-bit. In another embodiment (not shown), the input source SRC1 and the input source SRC2 are accumulated in 4 sets with an operation width SIMD_SIZE of 8 bits, and 8′b0 are added to the accumulation result respectively to perform zero-extension to generate the bytes HW3, HW2, HW1, and HW0, wherein the bytes HW3, HW2, HW1, and HW0 are all 16 bits. Please note that the accumulation result is located in the low-order bits of a byte, and the zero-extension is to pad 0s to the high-order bits of a byte. For example, the accumulation result of the byte HW3 is located in the lower 8 bits of the 16 bits, and the filled 8′b0 are located in the upper 8 bits of the 16 bits. The following is the same, and is not repeated herein. It is worth mentioning that, in the present embodiment, when the SIMD_ALU performs a sum operation on 8 bits, the operation result may only be stored in one 8 bits and may not be carried into the 9th bits. That is to say, since the carry-in part is discarded, the zero-extension in the input source or in the accumulation result does not affect the final result.

Next, the vector processor 10 uses the bytes HW2 and HW0 as the input source SRC1, and uses the bytes HW3 and HW1 as the input source SRC2. Specifically, the multiplexer MUX3 may select the bytes HW2 and HW0 as the input source SRC1 based on the state parameter STATE corresponding to the normal reduction operation, and the multiplexer MUX4 may select the bytes HW3 and HW1 as the input source SRC2 based on the state parameter STATE corresponding to the normal reduction operation. The arithmetic logic unit ALU may add 2 groups of 16′b0 to the input source SRC1 and the input source SRC2 respectively, and performs 4 sets of accumulation operations with an operation width SIMD_SIZE of 16 bits on the input source SRC1 and the input source SRC2, thereby generating the bytes W1 and W0, wherein the bytes W1 and W0 are both 32-bit. In another embodiment (not shown), the input source SRC1 and the input source SRC2 are accumulated in 2 sets with an operation width SIMD_SIZE of 16 bits, and 16′b0 are added to the accumulation result to perform zero-extension to generate the bytes W1 and W0, wherein the bytes W1 and W0 are both 32 bits.

Next, the vector processor 10 uses the byte W0 as the input source SRC1, and uses the byte W1 as the input source SRC2. Specifically, the multiplexer MUX3 may select the byte W0 as the input source SRC1 based on the state parameter STATE corresponding to the normal reduction operation, and the multiplexer MUX4 may select the byte W1 as the input source SRC2 based on the state parameter STATE corresponding to the normal reduction operation. The arithmetic logic unit ALU may add 1 group of 32′b0 to the input source SRC1 and the input source SRC2 respectively, and performs 2 sets of accumulation operations with an operation width SIMD_SIZE of 32 bits on the input source SRC1 and the input source SRC2, thereby generating a byte DW0 (that is, double-word), wherein the byte DW0 is 64-bit. In another embodiment (not shown), the input source SRC1 and the input source SRC2 are accumulated in 1 set with an operation width SIMD_SIZE of 32 bits and 32′b0 are added to the accumulation result to perform zero-extension to generate the byte DW0, wherein the byte DW0 is 64 bits and used as the normal reduction output NOUT of the normal reduction operation (that is, the normal reduction result, corresponding to the result of the lane output LCO[E*] in the Single Lane Reduction State 205). When the element length ELEN is 16 bits, the vector processor 10 uses the bytes HW2 and HW0 in the lane output LCO_L0 (second reduction result) as the input source SRC1, and uses the bytes HW3 and HW1 in the lane output LCO_L0 as the input source SRC2. For the subsequent process, please refer to the related content that the element length ELEN is 8 bits, which is not repeated herein. Similarly, when the element length ELEN is 32 bits, the vector processor 10 uses the byte W0 in the lane output LCO_L0 (second reduction result) as the input source SRC1, and uses the byte W1 in the lane output LCO_L0 as the input source SRC2. For the subsequent process, please refer to the related content that the element length ELEN is 8 bits, which is not repeated herein. Compared to FIG. 6, the difference between different element lengths ELEN is that the starting position is different.

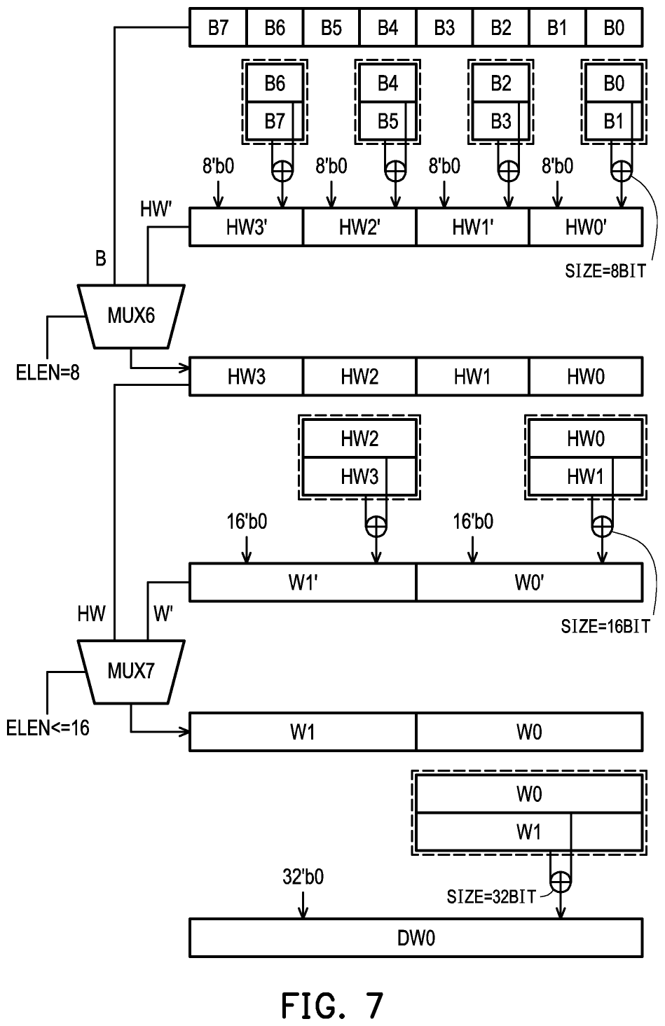

FIG. 7 is a schematic diagram of fast reduction in step S230 of a vector reduction method according to an embodiment of the invention. Referring to FIG. 2, FIG. 3, and FIG. 7, in the Single Lane Reduction State 205 in step S230, the vector processor 10 may perform one of a normal reduction operation or a fast reduction operation. In the fast reduction operation, the fast reduction circuit 310 performs arithmetic logic operations on a plurality of even-numbered parts and a plurality of odd-numbered parts in the reduced single lane output LCO_L0 (second reduction result) within one cycle based on the element length ELEN to generate a fast reduction output FOUT (fast reduction result).

In an embodiment, the fast reduction circuit 310 may divide the lane output LCO_L0 into 8 bytes such as bytes B7 to B0, and each of the bytes B7 to B0 consists of 8 bits, wherein the bytes B7, B5, B3, and B1 belong to an odd-numbered part ODD, and the bytes B6, B4, B2, and B0 belong to an even-numbered part EVEN. The difference between FIG. 7 and FIG. 6 is that FIG. 7 further includes a multiplexer MUX6 and a multiplexer MUX7, and the multiplexer MUX6 and the multiplexer MUX7 select different data DATA based on the element length ELEN. Please refer to Table 2 for details.

TABLE 2

| DATA | ELEN = 8 | ELEN = 16 | ELEN = 32 |
|---|---|---|---|
| HW0= | HW0′ | {B1, B0} | {B1, B0} |
| HW1= | HW1′ | {B3, B2} | {B3, B2} |
| HW2= | HW2′ | {B5, B4} | {B5, B4} |
| HW3= | HW3′ | {B7, B6} | {B7, B6} |
| W0= | W0′ | W0′ | {B3, B2, B1, B0} |
| W1= | W1′ | W1′ | {B7, B6, B5, B4} |

Referring to FIG. 7, in the same cycle, the fast reduction circuit 310 performs the following actions: providing bytes B7 to B0 as data B to the multiplexer MUX6. The byte B7 and the byte B6 are accumulated, and 8 0s are added to the accumulation result to perform zero-extension (that is, 8′b0 in FIG. 7) to generate the byte HW3′. By analogy, based on the pairs of bytes B5 and B4, bytes B3 and B2, bytes B1 and B0, the byte HW2′, HW1′, and HW0′ are generated respectively, and the bytes HW3′, HW2′, HW1′, and HW0′ are provided to the multiplexer MUX6 as data HW′. When the element length ELEN=8, the multiplexer MUX6 selects the data HW′ to be loaded into the bytes HW3, HW2, HW1, and HW0 respectively. When the element length ELEN=16 or 32, the multiplexer MUX6 selects the data B to be loaded into the bytes HW3, HW2, HW1, and HW0 respectively.

Accordingly, in the same cycle, the fast reduction circuit 310 provides the bytes HW3, HW2, HW1, and HW0 to the multiplexer MUX7 as data HW. Moreover, the fast reduction circuit 310 accumulates the byte B7 and the byte B6, and adds 16 0s to the accumulation result to perform zero-extension (that is, 16′b0 in FIG. 7) to generate the byte W1′. By analogy, the byte W0′ is generated based on the byte HW1 and the byte HW0, and the bytes W1‘ and W0’ are provided to the multiplexer MUX7 as data W′.

When the element length ELEN=8 or 16, the multiplexer MUX7 selects the data W′ to be loaded into the bytes W1 and W0 respectively. When the element length ELEN=32, the multiplexer MUX7 selects the data HW to be loaded into the bytes W1 and W0 respectively. In the same cycle, the fast reduction circuit 310 accumulates the byte W1 and the byte W0, and adds 32 zeros to the accumulation result to perform zero-extension (that is, 32′b0 in FIG. 7), so as to generate data DW0. In particular, the data DW0 is 64 bits.

In other words, in the fast reduction operation, the fast reduction circuit 310 uses a plurality of (smaller width) arithmetic logic units ALUs and multiplexers, so that all accumulation operations and selection operations may be completed in one cycle. Compared with the normal reduction operation, the fast reduction circuit 310 does not need a plurality of additional cycles to perform the iteration operations, thus improving the efficiency of the reduction operation.

Returning to FIG. 2 and FIG. 3. When the Single Lane Reduction State 205 in step S230 completes and returns to the Idle/Complete State 201 or the Lanes Reduction State 204 in step S220 completes and returns to the Idle/Complete State 201, based on the state parameter STATE and the operator OP corresponding to the previous state of the Idle/Complete State 201, the multiplexer MUX5 selects one of the reduced single lane output LCO_L0 (when the element length ELEN=64), the normal reduction output NOU (the normal reduction result when the element length ELEN<64, corresponding to the result of the lane output LCO[E*] in the Single Lane Reduction State 205), or the fast reduction output FOUT (fast reduction result when the element length ELEN<64) as the reduction output OUT (third reduction result) of the vector processor 10 in the vector reduction operation.

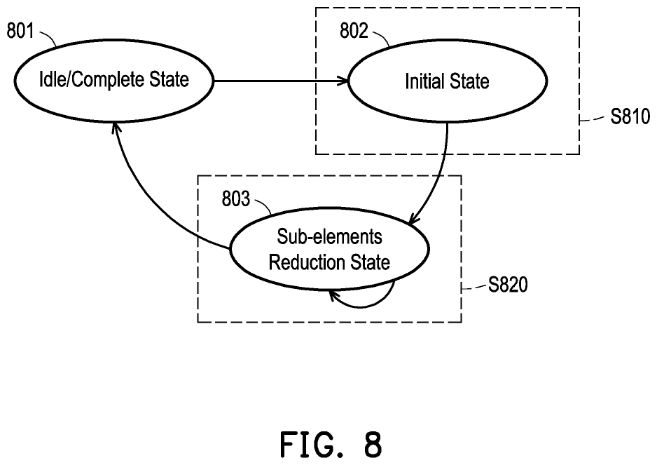

FIG. 8 is a schematic diagram of a finite state machine (FSM) for element reduction operations according to an embodiment of the invention. Referring to FIG. 8, the FSM of the element reduction operation includes an Idle/Complete State 801, an Initial State 802, and a Sub-elements Reduction State 803, and each state corresponds to a different state parameter STATE. The arithmetic logic unit ALU may perform actions of different states of the element reduction operation based on different state parameters STATE. In particular, the element reduction operation includes at least steps S810 and S820, wherein step S810 includes the Initial State 802, and step S820 includes the Sub-elements Reduction State 803.

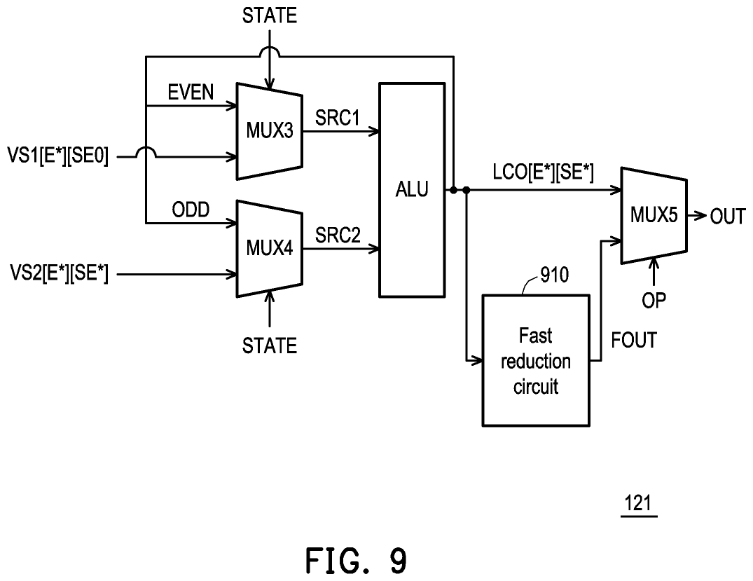

FIG. 9 is a schematic diagram of an arithmetic logic operation unit according to an embodiment of the invention. Please refer to FIG. 1 and FIG. 9, each of the lane 121 to the lane 124 configured for element reduction operations may include at least a multiplexer MUX3 (third multiplexer), a multiplexer MUX4 (fourth multiplexer), a arithmetic logic unit ALU, a fast reduction circuit 910, and a multiplexer MUX5 (fifth multiplexer). It should be mentioned that, the element reduction operation and the vector reduction operation may share at least the multiplexer MUX3 (third multiplexer), the multiplexer MUX4 (fourth multiplexer), the arithmetic logic unit ALU, the fast reduction circuit 910 (310), and the multiplexer MUX5 (fifth multiplexer) to perform different reduction operations using the same circuit. Thereby, the circuit area is reduced, but the shared part is not limited thereto. Also, compared to the vector reduction operation requiring a plurality of lanes to perform cooperative operations, the element reduction operation only needs to be independently performed in each lane, such as the lane 121.

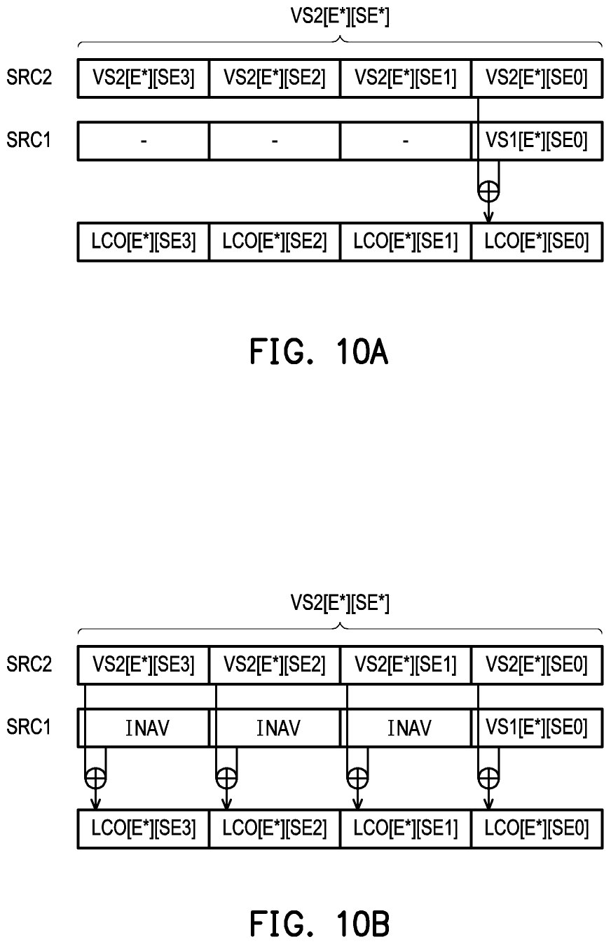

FIG. 10A is a schematic diagram of step S810 of an element reduction method according to an embodiment of the invention. FIG. 10B is a schematic diagram of step S810 of an element reduction method according to another embodiment of the invention. Please refer to FIG. 8, FIG. 9, and FIG. 10, in the Idle/Complete State 801, after the instruction fetch/decode/issue unit 140 issues the first micro-operation, the vector processor 10 proceeds to step S810 to perform an element reduction operation (first reduction operation). Step S810 includes at least the Initial State 802.

In FIG. 10A, in the present embodiment, the element VS1[E*] of the operand VS1 and the element VS2[E*] of the operand VS2 may have a plurality of sub-elements, such as an operand sub-element VS1[E*][SE0] and operand sub-elements VS2[E*][SE*]. In particular, VS2[E*] represents all elements in the operand VS2, and VS2[E*]I[SE*] represents all sub-elements in the operand VS2. The multiplexer MUX3 may select the operand sub-element VS1[E*][SE0] based on the state parameter STATE corresponding to the Initial State 802 as the input source SRC1. The multiplexer MUX4 may select the operand sub-elements VS2[E*][SE*] based on the state parameter STATE corresponding to the Initial State 802 as the input source SRC2. The arithmetic logic unit ALU is coupled to the output of the multiplexer MUX3 and the output of the multiplexer MUX4, and the arithmetic logic unit ALU performs an arithmetic logic operation on the input source SRC1 and the input source SRC2 to generate a lane output LCO[E*][SE*], such as a lane output LCO[E*][SE0], a lane output LCO[E*][SE1], a lane output LCO[E*][SE2], and a lane output LCO[E*][SE3].

In the Initial State 802, in the arithmetic logic operation performed by the arithmetic logic unit ALU on the input source SRC1 and the input source SRC2, please refer to FIG. 10A, taking the lane 121 as an example, the arithmetic logic unit ALU in the lane 121 may load the input source SRC1 with the operand sub-element VS1[EN][SE0] to the register corresponding to the lane 121, and load the input source SRC2 with the operand sub-elements VS2[EN][SE0] to VS2[EN]I[SE3] to the other four registers corresponding to the lane 121. Next, the arithmetic logic unit ALU of the lane 121 accumulates the operand sub-element VS1I[EN]I[SE0] and the operand sub-element VS2[EN]I[SE0] to generate the lane output LCO[EN]I[SE0] of the lane 121. The input source SRC2 with the operand sub-elements VS2[EN][SE1] to VS2[EN][SE3] is directly output as the lane output LCO[EN][SE1] to LCO[EN][SE3]. In this example, the lane output LCO[EN] has 4 sub-elements, that is, LCO[EN][SE0] to LCO[EN][SE3], and the invention does not limit the number of sub-elements. In FIG. 10B, in another embodiment, the difference from FIG. 10A is that the arithmetic logic unit ALU also loads the inactive value INAV to the operand sub-elements VS1[EN][SE1] to VS1[EN][SE3], respectively, and respectively accumulates with the operand sub-elements VS2[EN][SE1] to VS2[EN][SE3] to generate the lane output LCO[EN][SE1] to LCO[EN][SE3] of the lane 121.

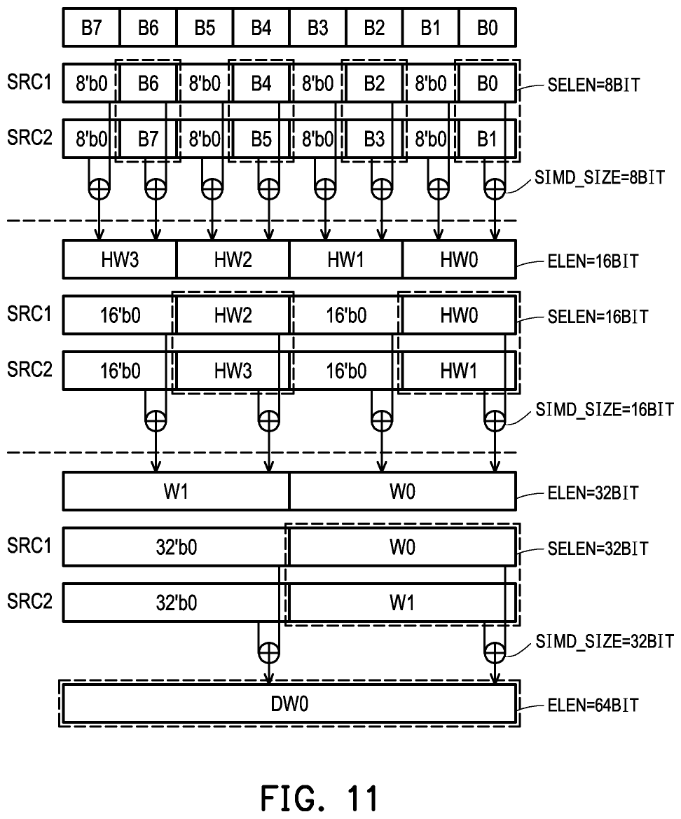

FIG. 11 is a schematic diagram of normal reduction in step S820 of an element reduction method according to an embodiment of the invention. Please refer to FIG. 8, FIG. 9, and FIG. 11, in the Sub-elements Reduction State 803 in step S820, the vector processor 10 may perform an element reduction operation. In a normal reduction operation in element reduction, the vector processor 10 determines, based on a sub-element length SELEN and the element length ELEN, the number of iterations for performing arithmetic logic operations on a plurality of even-numbered parts and a plurality of odd-numbered parts in the lane output LCO[EN] (first reduction result) to generate the normal reduction output NOUT (normal reduction result). In an embodiment, when the sub-element length SELEN is 8 bits, a lane output LCO[LM] (not shown, may contain one or a plurality of LCO[E*]) may be divided into 8 bytes such as bytes B7 to B0, and each of the bytes B7 to B0 consists of 8 bits, wherein the bytes B7, B5, B3, and B1 belong to an odd-numbered part ODD, and the bytes B6, B4, B2, and B0 belong to an even-numbered part EVEN. When the sub-element length SELEN is 16 bits, the lane output LCO[LM] may be divided into 4 bytes such as bytes HW3 to HW0, and each of the bytes HW3 to HW0 may consist of 16 bits, wherein the bytes HW3 and HW1 belong to an odd-numbered part ODD and the bytes HW2 and HW0 belong to an even-numbered part EVEN. When the sub-element length SELEN is 32 bits, the lane output LCO[LM] may be divided into 2 bytes such as bytes W1 and W0, and each of the bytes W1 and W0 consists of 32 bits, wherein the byte W1 belongs to an odd-numbered part ODD and the byte W0 belongs to an even-numbered part EVEN.

It should be noted that the difference between FIG. 6 and FIG. 11 is that the vector reduction operation of FIG. 6 determines the starting point of the iteration operations based on the element length ELEN, and the element reduction operation of FIG. 11 determines the starting point of the iteration operations based on the sub-element length SELEN. Moreover, the end point of the iteration operations in the vector reduction operation of FIG. 6 is always the normal reduction output NOUT which consists of the byte DW0 (that is, the normal reduction result, corresponding to the lane output LCO[LM]), and the end point of the iteration operations in the element reduction operation of FIG. 11 is flexibly adjustable based on the element length ELEN.

For example, when the sub-element length SELEN is 8 bits and the element length ELEN is 16 bits, the vector processor 10 may use the bytes B6, B4, B2, B0 in the lane output LCO[LM](first reduction result) as the input source SRC1 and use the bytes B7, B5, B3, and B1 in the lane output LCO[LM] as the input source SRC2. Specifically, the multiplexer MUX3 may select the even-numbered part EVEN of the lane output LCO[LM] as the input source SRC1 based on the state parameter STATE corresponding to the normal reduction operation, and the multiplexer MUX4 may select the odd-numbered part ODD of the lane output LCO[LM] as the input source SRC2 based on the state parameter STATE corresponding to the normal reduction operation. In an embodiment, the arithmetic logic unit ALU may add 4 groups of 8′b0 to the input source SRC1 and the input source SRC2 respectively, and performs 8 sets of accumulation with an operation width SIMD_SIZE of 8 bits on the input source SRC1 and the input source SRC2, thereby generating the bytes HW3, HW2, HW1, and HW0, wherein the bytes HW3, HW2, HW1, and HW0 are all 16-bit and used as the normal reduction output NOUT (that is, normal reduction result, corresponding to the lane output LCO[LM]).

If the sub-element length SELEN is 8 bits and the element length ELEN is 64 bits, following the above, after the bytes HW3, HW2, HW1, and HW0 are generated, the vector processor 10 uses the bytes HW2 and HW0 as the input source SRC1, and uses the bytes HW3 and HW1 as the input source SRC2. Specifically, the multiplexer MUX3 may select the bytes HW2 and HW0 as the input source SRC1 based on the state parameter STATE corresponding to the normal reduction operation, and the multiplexer MUX4 may select the bytes HW3 and HW1 as the input source SRC2 based on the state parameter STATE corresponding to the normal reduction operation. In an embodiment, the arithmetic logic unit ALU may add 2 groups of 16′b0 to the input source SRC1 and the input source SRC2 respectively, and performs 4 sets of accumulation with an operation width SIMD_SIZE of 16 bits on the input source SRC1 and the input source SRC2, thereby generating the bytes W1 and W0, wherein the bytes W1 and W0 are both 32-bit. Next, the vector processor 10 uses the byte W0 as the input source SRC1, and uses the byte W1 as the input source SRC2. Specifically, the multiplexer MUX3 may select the byte W0 as the input source SRC1 based on the state parameter STATE corresponding to the normal reduction operation, and the multiplexer MUX4 may select the byte W1 as the input source SRC2 based on the state parameter STATE corresponding to the normal reduction operation. In an embodiment, the arithmetic logic unit ALU may add 1 group of 32′b0 to the input source SRC1 and the input source SRC2 respectively, and performs 2 sets of accumulation with an operation width SIMD_SIZE of 32 bits on the input source SRC1 and the input source SRC2, thereby generating the byte DW0, wherein the byte DW0 is 64-bit and the byte DW0 is used as the normal reduction output NOUT (that is, normal reduction result, corresponding to the lane output LCO[LM]). Similarly, for the combination of other element lengths ELEN and sub-element lengths SELEN, please refer to the above. The difference between different sub-element lengths SELEN is that the starting position is different, and the difference between different element lengths ELEN is that the end position is different, which is not repeated herein.

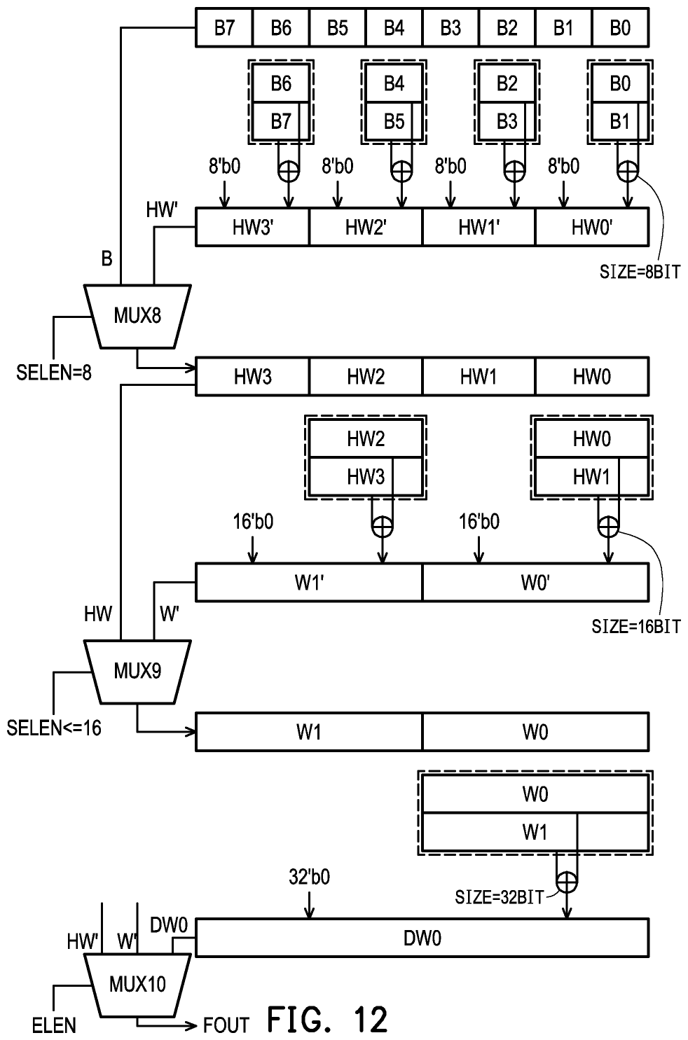

FIG. 12 is a schematic diagram of fast reduction operation in step S820 of an element reduction method according to an embodiment of the invention. Please refer to FIG. 8, FIG. 9, and FIG. 12, in the Sub-elements Reduction State 803 in step S820, the vector processor 10 may perform a fast reduction operation. In the fast reduction operation, the fast reduction circuit 910 performs arithmetic logic operations on a plurality of even-numbered parts and a plurality of odd-numbered parts in the lane output LCO[LM] (first reduction result) to generate the fast reduction output FOUT (fast reduction result) within one cycle based on the sub-element length SELEN and the element length ELEN.

In an embodiment, the fast reduction circuit 910 divides the lane output LCO[LM] into 8 bytes such as bytes B7 to B0, and each of the bytes B7 to B0 consists of 8 bits, wherein the bytes B7, B5, B3, and B1 belong to an odd-numbered part ODD, and the bytes B6, B4, B2, and B0 belong to an even-numbered part EVEN. The difference between FIG. 12 and FIG. 11 is that FIG. 12 further includes a multiplexer MUX8, a multiplexer MUX9, and a multiplexer MUX10. The multiplexer MUX8 and the multiplexer MUX9 select different data DATA based on the sub-element length SELEN. Please refer to Table 3 for details.

TABLE 3

| DATA | SELEN = 8 | SELEN = 16 | SELEN = 32 |
|---|---|---|---|
| HW0= | HW0′ | {B1, B0} | {B1, B0} |
| HW1= | HW1′ | {B3, B2} | {B3, B2} |
| HW2= | HW2′ | {B5, B4} | {B5, B4} |
| HW3= | HW3′ | {B7, B6} | {B7, B6} |
| W0= | W0′ | W0′ | {B3, B2, B1, B0} |
| W1= | W1′ | W1′ | {B7, B6, B5, B4} |

Referring to FIG. 12, in the same cycle, the fast reduction circuit 910 performs the following actions: providing bytes B7 to B0 as data B to the multiplexer MUX8. The byte B7 and the byte B6 are accumulated with an operation width SIZE of 8 bits, and 8 0s are added to the accumulation result to perform zero-extension (that is, 8′b0 in FIG. 12) to generate the byte HW3′. By analogy, based on the pairs of bytes B5 and B4, bytes B3 and B2, bytes B1 and B0, the bytes HW2′, HW1′, and HW0′ are generated respectively, and the bytes HW3′, HW2′, HW1′, and HW0′ are provided to the multiplexer MUX8 as data HW′. When the element length SELEN=8, the multiplexer MUX8 selects the data HW′ to be loaded into the bytes HW3, HW2, HW1, and HW0 respectively. When the element length SELEN=16, 32, the multiplexer MUX8 selects the data B to be loaded into the bytes HW3, HW2, HW1, and HW0 respectively.

Accordingly, in the same cycle, the fast reduction circuit 910 provides the bytes HW3, HW2, HW1, and HW0 to the multiplexer MUX9 as data HW. Moreover, the fast reduction circuit 910 accumulates the byte B7 and the byte B6 with the operation width SIZE of 16 bits, and adds 16 0s to the accumulation result to perform zero-extension (that is, 16′b0 in FIG. 12) to generate byte W1′. By analogy, the byte W0′ is generated based on the byte HW1 and the byte HW0, and the bytes W1‘ and W0’ are provided to the multiplexer MUX9 as data W′.

When the sub-element length SELEN=8 or 16, the multiplexer MUX9 selects the data W′ to be loaded into the bytes W1 and W0 respectively. When the sub-element length SELEN=32, the multiplexer MUX9 selects the data HW to be loaded into the bytes W1 and W0 respectively. In the same cycle, the fast reduction circuit 910 accumulates the byte W1 and the byte W0 with an operation width SIZE of 32 bits, and adds 32 zeros to the accumulation result to perform zero-extension (that is, 32′b0 in FIG. 12), so as to generate data DW0. In particular, the data DW0 is 64 bits.

In the present embodiment, the multiplexer MUX10 receives the data HW′, the data W′, and the data DW0, and the multiplexer MUX10 selects one of the data HW′, the data W′, or the data DW0 as the fast reduction output FOUT (fast reduction result) based on the element length ELEN. Specifically, when the element length ELEN is 16 bits, the multiplexer MUX10 may select the data HW′ as the fast reduction output FOUT. When the element length ELEN is 32 bits, the multiplexer MUX10 may select the data W′ as the fast reduction output FOUT. When the element length ELEN is 64 bits, the multiplexer MUX10 may select the data DW0 as the fast reduction output FOUT.

In other words, in the fast reduction operation, the fast reduction circuit 910 uses a plurality of multiplexers and (smaller width) ALUs, so that all accumulation operations and selection operations may be completed in one cycle. Compared with the normal reduction operation, the fast reduction circuit 910 does not need a plurality of additional cycles to perform the iteration operations, thus improving the efficiency of the reduction operation.

It is worth mentioning that the arithmetic logic operations in the normal reduction operations of the invention are usually arithmetic operations, such as finding a maximum value MAX, finding a minimum value MIN, and finding an accumulated value SUM. Moreover, arithmetic logic operations in fast reduction operations are usually logic operations, such as logical AND, OR, and XOR.

In other embodiments, the accumulation operation described above may be supplemented with a saturation reduction operation. Specifically, furthermore each accumulation operation checks whether the accumulation result is above the maximum saturation value or below the minimum saturation value. If the accumulated result is greater than the maximum saturation value, the accumulation result is replaced with the maximum saturation value, and if the accumulation result is less than the minimum saturation value, the accumulation result is replaced with the minimum saturation value.

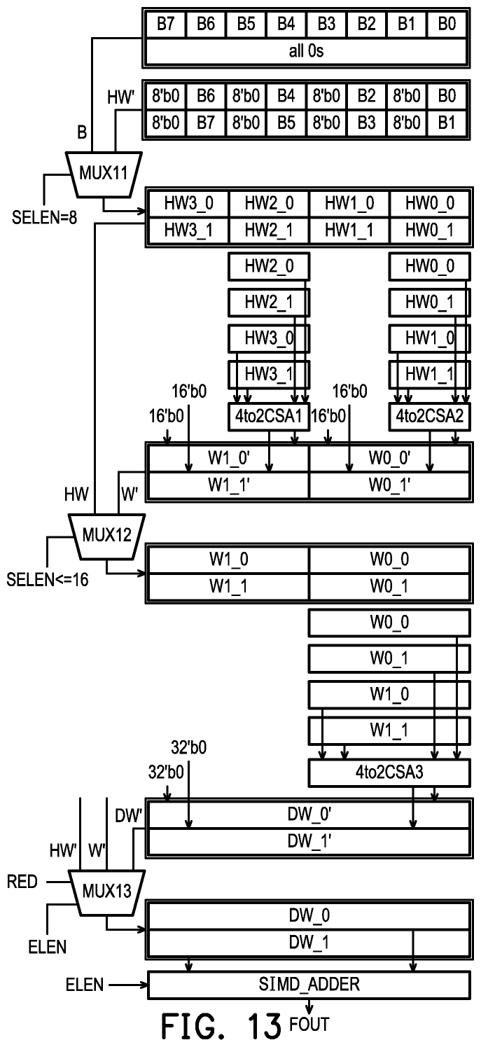

FIG. 13 is a schematic diagram of the fast reduction in steps S230 and S820 of a integer sum vector reduction and an integer sum element reduction method according to another embodiment of the invention. In particular, the fast reduction of FIG. 13 may be configured for vector reduction and element reduction. Please refer to FIG. 7 and FIG. 13. The difference between FIG. 13 and FIG. 7 is that in FIG. 13, the fast reduction circuit (not shown) expands the number of bytes by adding 0s to columns and adding 0s to rows of bytes B7 to B0 respectively, to generate the data B and the data HW′. The multiplexer MUX11 loads one of the data B or the data HW′ into the bytes HW3_0, HW3_1, HW2_0, HW2_1, HW1_0, HW1_1, HW0_0, HW0_1 based on the sub-element length SELEN (equivalent to the element length ELEN). Please refer to FIG. 7 for the selection method, which is not repeated herein. In the present embodiment, taking the data HW′ as an example, the byte B6 and the byte B7 are not added, but the bytes B6 and 0 are loaded into HW3_0, and the bytes B7 and 0 are loaded into HW3_1, and so on.

Continuing from the above, in the same cycle, the fast reduction circuit provides the bytes HW3_0, HW3_1, HW2_0, HW2_1, HW1_0, HW1_1, HW0_0, HW0_1 to the multiplexer MUX12 as the data HW. The fast reduction circuit folds the bytes HW3_0, HW3_1, HW2_0, HW2_1 and loads them in parallel into a 4-to-2 SIMD carry save adder compressor (4to2CSA1), to compress four input bytes into two output bytes, and 0s are added to perform zero-extension (that is, 16′b0 in FIG. 13) to be loaded into bytes W1_0′ and W1_1′. The fast reduction circuit folds the bytes HW1_0, HW1_1, HW0_0, HW0_1 and loads them in parallel into a 4-to-2 SIMD carry save adder compressor (4to2CSA2), to compress four input bytes into two output bytes, and 0s are added to perform zero-extension (that is, 16′b0 in FIG. 13) to be loaded into bytes W0_0′ and W0_1′. The fast reduction circuit provides the byte W1_0′, the byte W1_1′, the byte W0_0′, and the byte W0_1′ to the multiplexer MUX12 as the data W′.

In the same cycle, the multiplexer MUX12 loads one of the data HW or the data W′ into the bytes W1_0, W1_1, W0_0, and W0_1 based on the sub-element length SELEN (equivalent to the element length ELEN). The fast reduction circuit folds the bytes W1_0, W1_1, W0_0, and W0_1 and loads them in parallel into a 4-to-2 SIMD carry save adder compressor (4to2CSA3), to compress four input bytes into two output bytes, and 0s are added to perform zero-extension (that is, 32′b0 in FIG. 13) to be loaded into bytes DW_0′ and DW_1′. The fast reduction circuit provides the byte DW_0′ and the byte DW_1′ to the multiplexer MUX13 as data DW′.

Then, in the same cycle, the multiplexer MUX13 has different operation modes based on a received control signal RED. Specifically, based on the control signal RED, when the operation is vector reduction, the sub-element length SELEN of the multiplexers MUX11 and MUX12 is equivalent to the element length ELEN, and the multiplexer MUX13 always selects the data DW′ as the output. Moreover, based on the control signal RED, when the operation is element reduction, the multiplexer MUX13 selects one of the data HW′, W′, or DW′ based on the element length ELEN to be loaded into the bytes DW_0 and DW_1. Next, the single-instruction-multiple-data adder SIMD_ADDER accumulates the byte DW_0 and the byte DW_1 based on the element length ELEN to generate the fast reduction output FOUT.

It should be mentioned that, in FIG. 13, the 4-to-2 SIMD carry save adder compressors 4to2CSA1, 4to2CSA2, and 4to2CSA3 have short logic delay, and the single-instruction-multiple-data adder SIMD_ADDER has relatively long logic delay. The fast reduction circuit of FIG. 13 may adopt shorter logic delay CSAs to reduce the number of operands, and adopt a relatively longer logic delay SIMD_ADDER for the final addition operation to reduce the total logic delay of the adders in FIG. 7, so as to further improve the efficiency of the fast reduction operation.

In other embodiments, vector reduction operations may also be applied to vector dot product reduction. Specifically, dot product reduction may perform fast element-wise multiplication between source elements and then accumulate the result into a destination scalar element. It should be noted that, in the present embodiment, the definition of the dot product is, for example, multiplying each element VS1[E*] in the operand VS1 and each element VS2[E*] in the operand VS2 to obtain a product element MUL[E*] (MUL[E*]=VS1[E*]×VS2[E*]), the first element MUL[E0] of the product element is added to the operand VS3[E0] (that is, VD[E0]) to obtain a multiply-accumulate element MAC[E0] (MAC[E0]=VS1[E0]×VS2[E0]+VS3[E0]), and the other elements MUL[E*] of the product element are added to the operand 0 to obtain the multiply-accumulate element MAC[E*] (the value thereof is equivalent to MUL[E*], MAC[E*]=VS1[E*]×VS2[E*]+0). In particular, when the unit vector length multiplier LMUL′ is equal to 1, all multiply-accumulate elements MAC[E*] are directly accumulated (that is, IMAC[E*]) after the first iteration is completed. When the unit vector length multiplier LMUL′ is greater than 1, the intermediate value (that is, multiply-accumulate element MAC[E*]) is loaded to the source input ACC[E*] after each iteration, and in the next iteration, the multiplication result of the operand VS1[E*] multiplied with the operand VS2[E*] is added to the source input ACC[E*] (that is, MAC[E*]′=VS1[E*]′VS2[E*]′+ACC[E*]), until all iterations are completed, and then accumulate all the elements inside the source input ACC[E*] (that is, ΣACC[E*]).

In other embodiments, the vector reduction operation may also be applied to huge-wide SIMD width. For example, the data path length (DLEN) may be 2048 bits, and the number of lanes may be equal to 2048/64=32. In the present embodiment, the number of iterations of the Lanes Reduction State of the vector reduction operation is 5. In other words, compared to reducing 4 lanes to 1 lane in FIG. 5A and FIG. 5B, the present embodiment may reduce 32 lanes to 1 lane. The rest of the steps are similar to the previous ones and are not repeated herein.

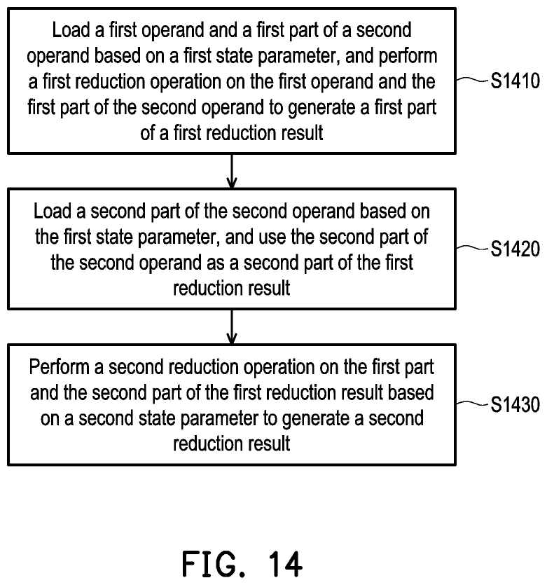

FIG. 14 is a flowchart of a vector reduction operation according to an embodiment of the invention. Vector reduction operations are available for vector processors. In step S1410, a vector processor loads a first operand and a first part of a second operand based on a first state parameter, and performs a first reduction operation on the first operand and the first part of the second operand to generate a first part of a first reduction result. Then, in step S1420, the vector processor loads a second part of the second operand based on the first state parameter, and uses the second part of the second operand as a second part of the first reduction result. In step S1430, the vector processor performs a second reduction operation on the first part and the second part of the first reduction result based on a second state parameter to generate a second reduction result.

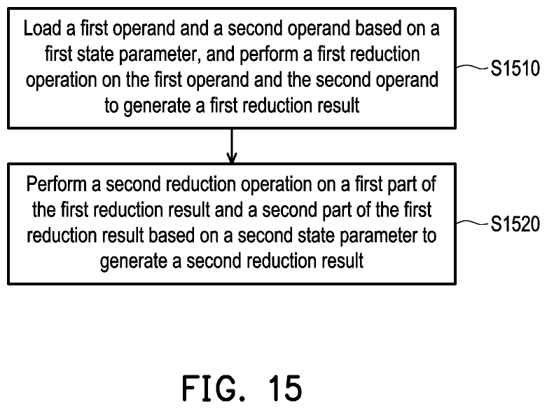

FIG. 15 is a flowchart of an element reduction operation according to an embodiment of the invention. Element reduction operations are available for vector processors. In step S1510, the vector processor loads a first operand and a second operand based on a first state parameter, and performs a first reduction operation on the first operand and the second operand to generate a first reduction result. Next, in step S1520, the vector processor performs a second reduction operation on a first part of the first reduction result and a second part of the first reduction result based on a second state parameter to generate a second reduction result.

Based on the above, the vector processor of the invention may execute different steps in the reduction operation with the same circuit based on the state parameters, thereby saving circuit area and improving reduction operation performance. Moreover, the vector processor may perform the vector reduction operation and the element reduction operation with the same circuit structure, so as to further save circuit area. Moreover, in the invention, the number of iterations may also be flexibly adjusted based on the unit vector length multiplier to handle applications with larger data path lengths or vector register lengths, and a normal reduction operation or a fast reduction operation may be implemented when the element length is less than the length of a single lane for flexible design based on actual needs, so as to optimize the hardware performance index or software performance index.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A vector processor, comprising:
a vector register file; and
a first lane coupled to the vector register file for loading a first operand and a second operand based on a first state parameter, wherein the first lane performs a first reduction operation on the first operand and the second operand to generate a first reduction result, and the first lane performs a second reduction operation on a first part of the first reduction result and a second part of the first reduction result based on a second state parameter to generate a second reduction result.

2. The vector processor of claim 1, wherein the second reduction result has the same bit length as the first reduction result.

3. The vector processor of claim 1, wherein the second reduction operation comprises:
determining a number of iterations for performing arithmetic logic operations on a plurality of even-numbered parts and a plurality of odd-numbered parts in the first reduction result based on a sub-element length and an element length to generate the second reduction result.

4. The vector processor of claim 1, wherein the second reduction operation comprises:
performing arithmetic logic operations on a plurality of even-numbered parts and a plurality of odd-numbered parts in the first reduction result based on a sub-element length and an element length to generate the second reduction result within one cycle.

5. The vector processor of claim 1, wherein the first lane comprises:
a third multiplexer selecting one of an even-numbered part of a lane output or one sub-element in the first operand as a first input source based on a state parameter;
a fourth multiplexer selecting one of an odd-numbered part of the lane output or a plurality of sub-elements in the first operand as a second input source based on the state parameter;
an arithmetic logic unit coupled to the third multiplexer and the fourth multiplexer and configured to perform an arithmetic logic operation on the first input source and the second input source to generate the lane output;
a fast reduction circuit coupled to the arithmetic logic circuit to perform arithmetic logic operations on the even-numbered part and the odd-numbered part in the lane output based on a sub-element length and an element length to generate a fast reduction result within one cycle; and
a fifth multiplexer coupled to the arithmetic logic unit and the fast reduction circuit and configured to select one of the lane output or the fast reduction result as the second reduction result based on an operator.

6. An element reduction method, comprising:
loading a first operand and a second operand based on a first state parameter and performing a first reduction operation on the first operand and the second operand to generate a first reduction result; and
performing a second reduction operation on a first part and a second part of the first reduction result based on a second state parameter to generate a second reduction result.

7. The element reduction method of claim 6, wherein the second reduction result has a same bit length as the first reduction result.

8. The element reduction method of claim 6, wherein the second reduction operation comprises:
determining a number of iterations for performing arithmetic logic operations on a plurality of even-numbered parts and a plurality of odd-numbered parts in the first reduction result based on a sub-element length and an element length to generate the second reduction result.

9. The element reduction method of claim 6, wherein the second reduction operation comprises:
performing arithmetic logic operations on a plurality of even-numbered parts and a plurality of odd-numbered parts in the first reduction result based on a sub-element length and an element length to generate the second reduction result within one cycle.
